(19) United States
(12) Patent Application Publication
(10) Pub. No.: US 2023/0137014 A1
(43) Pub. Date: May 4, 2023

(54) NEURON ELEMENT, DIFFERENTIAL NEURON ELEMENT, A/D CONVERTER AND NEURAL NETWORK

(71) Applicant: SOLITON SYSTEMS K.K., Tokyo (JP)

(72) Inventors: Kenich HASHIMOTO, Tokyo (JP); Kazuhisa TAKAMURA, Tokyo (JP); Kunihiro KAJIHARA, Tokyo (JP); Teruhiko HAYASHI, Tokyo (JP)

(21) Appl. No.: 17/906,918

(22) PCT Filed: Jan. 1, 2022
(86) PCT No.: PCT/JP2022/000001

§ 371 Date: Sep. 21, 2022

(30) Foreign Application Priority Data
Jan. 18, 2021 (JP) 2021-006051

(51) Int. Cl. G06N 3/065

(52) U.S. Cl. CPC G06N 3/065

(57) ABSTRACT

This neuron element comprises: a first charge storage unit in which charge is stored by an input signal; and a signal processing unit that, if the charge stored in the first charge storage unit exceeds a first prescribed amount, outputs a second prescribed amount of charge from the first charge storage unit and generates a pulse signal. The signal processing unit performs prescribed processing for the second prescribed amount of charge.

### CROSS REFERENCE TO RELATED APPLICATIONS

This application is a national stage application, filed under 35 U.S.C. § 371, of International Application No. PCT/JP2022/000001, filed Jan. 1, 2022, which claims priority to Japan Application No. 2021-006051, filed Jan. 18, 2021, the contents of both of which as are hereby incorporated by reference in their entirety.

### BACKGROUND

### Technical Field

The present invention relates to a neuron element, a differential neuron element, an A/D converter, and a neural network.

### Description of Related Art

Conventionally, a spiking neural network circuit may comprise a synapse configured to generate an operation signal from a weighted input spike signal, and a plurality of neuron elements configured to generate an output spiking signal based on comparing a voltage of a membrane signal generated by an input of the operation signal with a predetermined threshold value (see U.S. Pat. Application Publication No. 2020/0160146).

Conventionally, the operation signal is given as a current signal. In each neuron element, its internal capacitor is charged by the current signals inputted from a plurality of neuron elements in a preceding stage. Then, when a voltage is generated at the internal capacitor and the voltage exceeds the predetermined threshold value, the neuron element generates an output spiking signal.

Aside from this, an A/D converter which converts an analog signal into a digital signal using a sigma-delta modulation is conventionally known (see Kenji Taniguchi, “Introduction to CMOS Analogue Circuitry for LSI-Design”, CQ Publishing Co.,Ltd., Dec. 1, 2004 and “Basics of Delta-Sigma ADCs: About Delta-Sigma Modulators″, retrieved in Jan. 12, 2021”, Internet URL: https://e2e.ti.eom/blogs_/japan/b/analog/archive/2017/02/03/1-adc).

FIG. 15 is a circuit diagram illustrating a basic configuration of the conventional sigma-delta A/D converter. The sigma-delta A/D converter includes a sigma-delta modulating unit that performs the sigma-delta modulation on an input analog signal and generates a 1-bit modulated pulse signal, and a digital filter that receives the modulated pulse signal and converts a number of pulses being received within a predetermined range on a time axis, for example, into an n-bit output digital signal.

### BRIEF SUMMARY

The present invention has been proposed to solve the problems posed by such prior art.

In accordance with various embodiments of the present disclosure, a neuron element is provided. In some embodiments, the neuron element comprises: a first charge accumulating unit configured to accumulate charges by an input signal; a signal processing unit which, based on a condition when the charges accumulated in the first charge accumulating unit exceed a first predetermined amount of charges, is configured to: discharge a second predetermined amount of charges from the first charge accumulating unit; generate a pulse signal; and perform a predetermined processing in relation to the second predetermined amount of charges.

In accordance with various embodiments of the present disclosure, a differential neuron element is provided. In some embodiments, the differential neuron element comprises: a charge accumulating unit which accumulates charges by a first input signal and a second input signal, the second input signal obtained by inverting a polarity of the first input signal; a signal processing unit which, based on a condition when the charges accumulated in the charge accumulating unit exceed a first predetermined amount of charges, is configured to: discharge a second predetermined amount of charges from the charge accumulating unit; generate a first pulse signal and a second pulse signal, the second pulse signal obtained by inverting a polarity of the first pulse signal; and perform a predetermined processing in relation to the second predetermined amount of charges.

In accordance with various embodiments of the present disclosure, an A/D converter is provided. The A/D converter comprises: a charge accumulating unit which accumulates charges by an input signal; a signal processing unit which, based on a condition when the charges accumulated in the charge accumulating unit exceed a first predetermined amount of charges, is configured to: discharge a second predetermined amount of charges from the charge accumulating unit; generate a pulse signal; perform a predetermined processing in relation to the second predetermined amount of charges; and a digital filter configured to perform a predetermined digital processing on the pulse signal generated by the signal processing unit.

In accordance with various embodiments of the present disclosure, a neural network is provided. The neural network comprises a plurality of neuron elements, wherein an input signal of any one of the neuron elements is obtained by a weighting addition processing of at least one of signals of at least one external input signal and an output signal of at least another one of the neuron elements, wherein an output signal of any of the neuron element becomes at least one of signals of at least one external output signal and a weighted input signal of the at least another one of the neuron elements.

The present invention makes it possible to suppress input signal data loss and power consumption.

### BRIEF DESCRIPTION OF THE FIGURES

FIG. 1 is a block diagram showing a functional configuration of a neuron element according to a first embodiment.

FIG. 2 is a flowchart showing operation steps of a neuron element.

FIG. 3 is a circuit diagram showing a configuration of a neuron element.

FIG. 4 is a timing chart showing temporal changes of respective signals in a neuron element.

FIG. 5 is a timing chart showing temporal changes of respective signals in a neuron element when a delay period becomes longer.

FIG. 6 is a circuit diagram showing a configuration of a neuron element according to a second embodiment.

FIG. 7 is a timing chart showing temporal changes of respective signals in a neuron element.

FIG. 8 is a timing chart showing temporal changes of respective signals in a neuron element when it is most likely to cause a condition that does not operate normally.

FIG. 9 is a circuit diagram showing a configuration of a neuron element according to a third embodiment.

FIG. 10 is a block diagram showing a functional configuration of an A/D converter according to a fourth embodiment.

FIG. 11 is a set of wave diagrams respectively showing an input analog signal, a modulated pulse signal, and an output digital signal, of a conventional sigma-delta A/D converter.

FIG. 12 is a set of wave diagrams respectively showing an input analog signal, a modulated pulse signal, and an output digital signal, of an A/D converter according to a fourth embodiment.

FIG. 13 is a diagram showing an exemplary configuration of a neural network according to a fifth embodiment.

FIG. 14 is a diagram showing a relation between an output signal xᵢ of a neuron element (i = 1,2,3) and a weighting coefficient wᵢ (i = 1,2,3).

FIG. 15 is a block diagram showing a functional configuration of a conventional sigma-delta A/D converter.

### DETAILED DESCRIPTION OF VARIOUS EMBODIMENTS

Hereinafter, embodiments in the present invention will be described in detail below with reference to the figures.

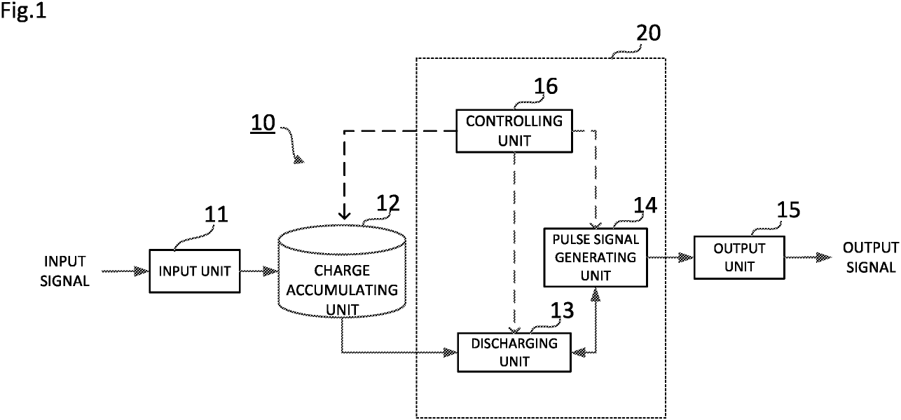

FIG. 1 is a block diagram showing a functional configuration of a neuron element 10 according to the first embodiment.

The neuron element 10 comprises an input unit 11, a charge accumulating unit 12, a discharging unit 13, a pulse signal generating unit 14, an output unit 15, and a controlling unit 16.

The input unit 11 supplies a current signal input from an outside (an input signal) to the charge accumulating unit 12. When the input signal is a voltage signal, for example, the input unit 11 converts the voltage signal to a current signal equivalent to the voltage signal using a predetermined method.

The charge accumulating unit 12 is supplied with the current signal from the input unit 11 to accumulate charges.

The discharging unit 13 discharges the charges accumulated in the charge accumulating unit 12 according to an instruction of the controlling unit 16 or according to a pulse signal generated by the pulse signal generating unit 14.

The pulse signal generating unit 14 generates the pulse signal based on an instruction of the controlling unit 16 or in response to the charges discharged by the discharging unit 13, and supplies the pulse signal to the output unit 15.

The output unit 15 outputs the pulse signal supplied from the pulse signal generating unit 14 to the outside. The output unit 15, if required, may output the pulse signal to the outside after shaping a waveform of the pulse signal supplied from the pulse signal generating unit 14 to a predetermined shape.

The controlling unit 16 measures, for example, a voltage generated at the charge accumulating unit 12 as an amount of accumulated charges in the charge accumulating unit 12. The controlling unit 16 instructs, to the pulse signal generating unit 14, a generation of a pulse signal when an amount of accumulated charges being measured (a measured amount of charges) exceeds a predetermined threshold value, and a generation stop of the pulse signal when the measured amount of charges no longer exceeds the threshold value.

Alternatively, the controlling unit 16 instructs, to the discharging unit 13, a discharge of a predetermined amount of charges from the charge accumulating unit 12 when a measured amount of charges exceeds a predetermined threshold value, and a discharge stop of charges from the charge accumulating unit 12 when the measured amount of charges no longer exceeds the threshold value.

The discharging unit 13 and the pulse signal generating unit 14 do not immediately execute a predetermined processing upon receiving an instruction from the controlling unit 16, but execute the predetermined processing after a certain period of time elapses. Also, the discharging unit 13, the pulse signal generating unit 14 and the controlling unit 16 are linked to each other as described above. For example, the discharging unit 13, the pulse signal generating unit 14 and the controlling unit 16 collectively function as the signal processing unit 20, which, when a measured amount of charges in the charge accumulating unit 12 exceeds a predetermined threshold value, discharges a predetermined amount of charges from the charge accumulating unit 12, and generates a pulse signal.

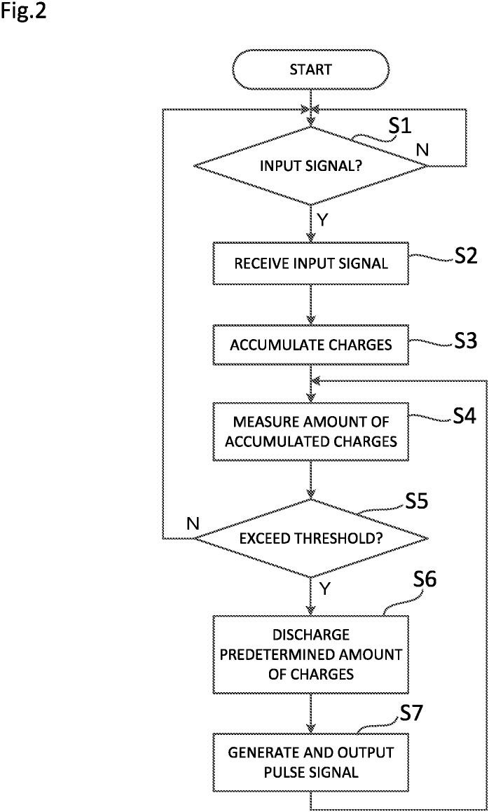

FIG. 2 is a flowchart showing operation steps of the neuron element 10.

The input unit 11, when there is an input signal from an outside (step S1), receives the input signal and supplies it to the charge accumulating unit 12 (step S2). Alternatively, the input unit 11, when the input signal is a voltage signal, converts the voltage signal to an equivalent current signal using a predetermined method, and supplies the converted current signal to the charge accumulating unit 12.

The charge accumulating unit 12 accumulates charges when the input signal is supplied from the input unit 11 (step S3).

The controlling unit 16 measures, for example, a voltage generated at the charge accumulating unit 12 as an amount of accumulated charges in the charge accumulating unit 12 (step S4) and, if the measured amount of accumulated charges exceeds a predetermined threshold value (step S5), the controlling unit 16 instructs, to the discharging unit 13, a discharge of a predetermined amount of charges. Accordingly, the discharging unit 13 discharges the predetermined amount of charges from the charge accumulating unit 12 (step S6). Alternatively, if the measured amount of charges in the charge accumulating unit 12 does not exceed the predetermined threshold value, the charges in the charge accumulating unit 12 is not discharged and the process returns to step S1.

Next, the controlling unit 16 instructs the pulse signal generating unit 14 to generate a pulse signal. Then, the pulse signal generating unit 14 generates the pulse signal (step S7). Alternatively, the pulse signal generating unit 14 may generate the pulse signal in accordance with an amount of charges discharged by the discharging unit 13 even without receiving the instruction from the controlling unit 16.

The output unit 15 outputs the pulse signal generated by the pulse signal generating unit 14 to the outside (step S7). Then, the process returns to step S4. Alternatively, the output unit 15, if required, may output the pulse signal to the outside after shaping a waveform of the pulse signal generated by the pulse signal generating unit 14 to a predetermined shape.

Alternatively, the controlling unit 16 may, when the measured amount of charges in the charge accumulating unit 12 exceeds the threshold value, firstly issue the instruction to the pulse signal generating unit 14, and then issue the instruction to the discharging unit 13. Alternatively, the discharging unit 13 may discharge the predetermined amount of charges in response to the pulse signal generated by the pulse signal generating unit 14, without receiving the instruction from the controlling unit 16.

Here, from a time when the measured amount of charges in the charge accumulating unit 12 exceeds the threshold value to a time when charges are actually discharged from the charge accumulating unit 12, there is a predetermined delay period. Therefore, charges are continuously accumulated in the charge accumulating unit 12 during this delay period. Similarly, there is a predetermined delay period between when the measured amount of charges in the charge accumulating unit 12 falls below the threshold value and when the discharge of charges from the charge accumulating unit 12 actually stops. Therefore, charges are continuously discharged from the charge accumulating unit 12 during the latter delay period.

As described above, when an amount of charges accumulated in the charge accumulating unit 12 exceeds a predetermined threshold value, the neuron element 10 outputs a pulse signal to an outside and discharges a predetermined amount of charges from the charge accumulating unit 12, thereby preventing the charge accumulating unit 12 from overflowing with the charges. In other words, by outputting the pulse signal, which corresponds to a quantity of charges overflowing from the charge accumulating unit 12 to the outside, the neuron element 10 can avoid a loss of data corresponding to an amount of the discarded charges.

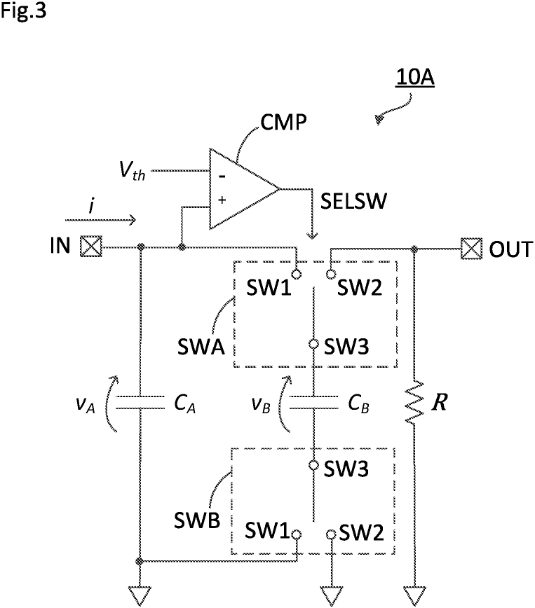

FIG. 3 is a circuit diagram showing a configuration of a neuron element 10A according to the present embodiment. The neuron element 10A is an exemplary configuration of the neuron element 10 shown in FIG. 1.

The neuron element 10A includes a capacitor C_{A}, a capacitor C_{B}, a comparator CMP, switches SWA and SWB, and a resistive load R. The switch SWA is, for example, a SPDT (Single-Pole Double-Throw) switch using the MOS transistors, and has three terminals, SW1, SW2 and SW3. The switch SWA conducts between the terminals SW1 and SW3, or between the terminals SW2 and SW3, depending on a control (selecting) signal from the comparator CMP. The switch SWB also has a same configuration as the switch SWA.

One terminal of the capacitor C_{A} is connected to an input terminal IN, and the other terminal thereof is grounded. One terminal of the capacitor C_{B} is connected to the terminal SW3 of the switch SWA, and the other terminal thereof is connected to the terminal SW3 of the switch SWB.

The terminal SW1 of the switch SWA is connected to the input terminal IN. The terminal SW1 of the switch SWB is grounded.

The terminal SW2 of the switch SWA is connected to the resistive load R and an output terminal OUT. The terminal SW2 of the switch SWB is grounded.

One terminal of the resistive load R is connected to the terminal SW2 of the switch SWA and the output terminal OUT, the other terminal is grounded. For this reason, the resistive load R has a function to generate a pulse signal in accordance with an amount of charges discharged from the capacitor C_{B} via the switch SWA.

The comparator CMP measures an amount of charges accumulated in the capacitor C_{A} as a voltage of the input terminal IN (= a voltage generated at the capacitor C_{A}) and determines whether or not the voltage being measured (the measured voltage v_{A}) exceeds a predetermined threshold voltage Vₜₕ. The comparator CMP supplies a selecting signal SW1 to the switches SWA and SWB when the measured voltage v_{A} exceeds the threshold voltage Vₜₕ, or supplies a selecting signal SW2 to the switches SWA and SWB when the measured voltage v_{A} does not exceed the threshold voltage Vₜₕ.

When the selecting signal is supplied from the comparator CMP, the switches SWA and SWB are switched as follows. That is, the switches SWA and SWB, when the selecting signal SW1 is supplied, conduct between the terminals SW1 and SW3 (switched to SW1). Furthermore, the switches SWA and SWB, when the selecting signal SW2 is supplied, conduct between the terminals SW2 and SW3 (switched to SW2).

Therefore, when the selecting signal SW1 is supplied to the switches SWA and SWB, the capacitors C_{A} and C_{B} are connected in parallel. On the other hand, when the selecting signal SW2 is supplied to the switches SWA and SWB, the capacitor C_{B} and the resistive load R are connected in parallel, and the charges accumulated in the capacitor C_{B} are discharged through the resistive load R.

Note that the other terminal of the capacitor C_{A}, the terminals SW1 and SW2 of the switch SWB, and the other terminal of the resistive load R are sufficient if they are equipotential, and are not limited to be grounded as shown in the present embodiment.

By the way, the switches SWA and SWB do not switch immediately when the measured voltage v_{A} during its ramping up exceeds the threshold voltage Vₜₕ or when the measured voltage v_{A} during its dropping falls below the threshold voltage Vₜₕ. That is, there is a predetermined delay period D_{cmp} from a time when the ramping up or dropping of the measured voltage v_{A} exceeds or falls below the threshold voltage Vₜₕ to a time when the switches SWA and SWB are actually switched.

Therefore, the measured voltage v_{A} continues to ramp up from the time when the threshold voltage Vₜₕ is exceeded until the delay period D_{cmp} elapses. When the capacitors C_{A} and C_{B} are connected in parallel at a time when the switches SWA and SWB are switched to SW1 after the delay period D_{cmp} has elapsed, the charges accumulated in the capacitor C_{A} flow into the capacitor C_{B}, and as a result, the measured voltage v_{A} drops rapidly.

The same is true if the measured voltage v_{A} of the capacitor C_{A} falls below the threshold voltage Vₜₕ. That is, even if the switches SWA and SWB are switched to SW1 and the measured voltage v_{A} drops abruptly and falls below the threshold voltage Vₜₕ, the parallel connection state of the capacitors C_{A} and C_{B} is retained until the delay period D_{cmp} elapses from that time. When the switches SWA and SWB are switched to SW2 after the delay period D_{cmp} has elapsed, the capacitor C_{B} is separated from the capacitor C_{A} and connected in parallel with the resistive load R.

The delay period D_{cmp} is a total sum of delays such as a delay caused by: an interconnect delay; gate delays of the MOS transistors constituting the switches SWA and SWB; and a delay at the comparator CMP. In particular, the delay caused by the comparator CMPs is determined from its output-capacitance Cₒᵤₜ, its transconductance gₘ and so on. Thus, by designing them appropriately, the delay period D_{cmp} is optimized.

When a signal is inputted from an outside, the neuron element 10A configured as described above operates as follows.

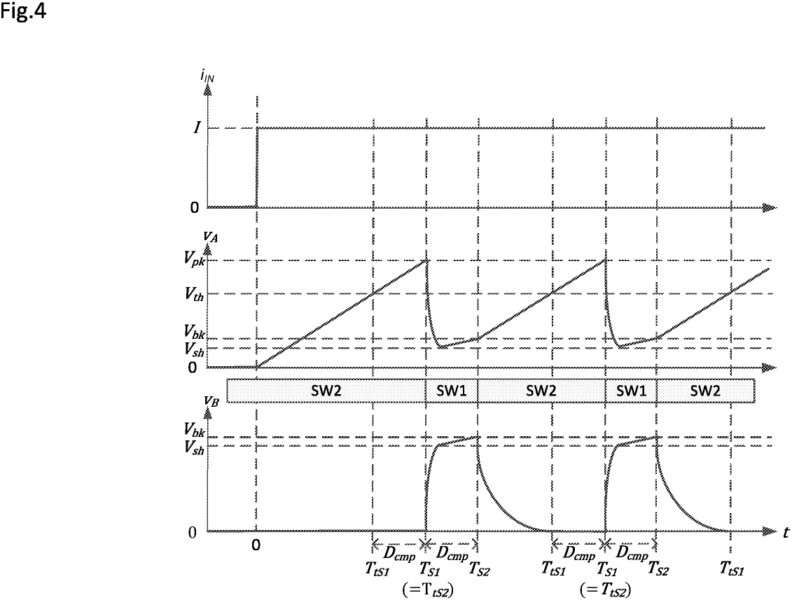

FIG. 4 is a timing chart showing temporal changes of respective signals in the neuron element 10A. Here, at its initial state, charges accumulated in the capacitors C_{A} and C_{B} shown in FIG. 3 are zero. Therefore, the measured voltage v_{A} of the capacitor C_{A} is 0. Since the measured voltage v_{A} is lower than the threshold voltage Vₜₕ, both the switches SWA and SWB are switched to SW2.

In FIG. 4, at a time t = 0, a constant current i_{IN} = I is inputted to the input terminal IN. In practice, however, a current input to the input terminal IN is not constant.

Incidentally, a normal operating condition of the neuron element 10A refers to a condition under which the neuron element 10A operates normally even in the most stringent state, specifically, the state in which an allowable maximum instantaneous input current Iₘₐₓ is continuously inputted as the constant current. As long as this normal operating condition is satisfied, it is ensured that the neuron element 10A operates normally even when a current that changes arbitrarily but does not exceed Iₘₐₓ is inputted. The normal operating condition will be described in detail later.

When the constant current i_{IN} = I is inputted to the input terminal IN, the charges are accumulated in the capacitor C_{A}, and the measured voltage v_{A} of the capacitor C_{A} gradually ramps up.

At a time t = T_{tS1}, when the measured voltage v_{A} exceeds the threshold voltage Vₜₕ, the comparator CMP supplies the selecting signal SW1 to the switches SWA and SWB. Consequently, the switches SWA and SWB start their switching operations from SW2 to SW1.

However, as described above, the switching operations from SW2 to SW1 for the switches SWA and SWB are not executed immediately. A time t at which SW2 is actually switched to SW1 is t = T_{S1} after the delay period D_{cmp} from the time t = T_{tS1}.

That is, in a period from the time t = T_{tS1} to the time t = T_{S1}, the charges are continuously accumulated in the capacitor C_{A}. As a result, the measured voltage v_{A} ramps up continuously even if it exceeds the threshold voltage Vₜₕ, and reaches a peak voltage Vₚₖ just before the time t = T_{S1}.

At the time t = T_{S1}, when the switches SWA and SWB are switched from SW2 to SW1, the capacitors C_{A} and C_{B} are connected in parallel, and the charges accumulated in the capacitor C_{A} flow into the capacitor C_{B}. Therefore, the measured voltage v_{A} of the capacitor C_{A} drops exponentially. Also, the voltage v_{B} generated at the capacitor C_{B} ramps up exponentially.

Here, a parasitic resistance r between the capacitors C_{A} and C_{B} is so small that a time constant τ₁ between the capacitors C_{A} and C_{B} is negligible compared with the delay period D_{cmp}. As a consequence, at a moment when the time t = T_{S1} is exceeded, a part of charges accumulated in the capacitors C_{A} flow into the capacitor C_{B}, and the voltage v_{A} and v_{B} respectively generated at the capacitors C_{A} and C_{B} have become equal to Vₛₕ.

At this time, the measured voltage v_{A} (= v_{B} = Vₛₕ) is less than the threshold voltage Vₜₕ, and so the comparator CMP supplies the selecting signal SW2 to the switches SWA and SWB. The switches SWA and SWB then start the switching operation from SW1 to SW2 at a time t = T_{tS2}.

Here, as described above, even when the measured voltage v_{A} (= v_{B} = Vₛₕ) becomes lower than the threshold voltage Vₜₕ, the switching operations of the switches SWA and SWB from SW1 to SW2 are not executed immediately. A time t at which SW1 is actually switched to SW2 is t = T_{S2} after the delay period D_{cmp} from the time t = T_{tS2}.

That is, in a period from the time t = T_{tS2} to the time t = T_{S2}, the charges are continuously accumulated in both of the capacitors C_{A} and C_{B}. Consequently, the measured voltage v_{A} (= v_{B}) ramps up and reaches the voltage V_{bk} just before the time t = T_{S2}.

Note that the measured voltage v_{A}’'s ramp-up speed (gradient) at this time is I/(C_{A} + C_{B}) and is smaller than a ramp-up speed of the measured voltage v_{A} from the time t = 0 to the time t ═ T_{tS1} (═ I/C_{A}). The reason for this is that the charges flowed by the input constant current i_{IN} = I are accumulated in both of the parallel connected capacitors C_{A} and C_{B}.

When the switches SWA and SWB are switched from SW1 to SW2, the capacitor C_{B} is connected in parallel with the resistive load R. As a result, the charges accumulated in the capacitor C_{B} are discharged through the resistive load R. Then, the voltage v_{B} generated at the capacitor C_{B} rapidly drops according to an exponential function having a time constant τ₂ (= R ▪ C_{B}). The voltage v_{B} is supplied to an external load as a voltage pulse signal through the output terminal OUT.

On the other hand, the capacitor C_{A} is separated from the capacitor C_{B}. Consequently, the capacitor C_{A} is charged by the input constant current i_{IN} = I, and the measured voltage v_{A} of the capacitor C_{A} ramps up. A ramp-up speed of the measured voltage v_{A} at this time is the same as the ramp-up speed of the measured voltage v_{A} from the time t = 0 to the time t = T_{tS1} (═ I/C_{A}).

At a second time t = T_{tS1}, the measured voltage v_{A} again exceeds the threshold voltage Vₜₕ, and the switches SWA and SWB start the switching operations from SW2 to SW1. At a second time t = Tₛ₁ after the delay period D_{cmp} has elapsed from the second time t = T_{tS1}, the switches SWA and SWB are switched from SW2 to SW1. As a consequence, the charges accumulated in the capacitor C_{A} flow into the capacitor C_{B}.

As described above, when the constant current i_{IN} = I is inputted to the input terminal IN, the neuron element 10A in the first embodiment outputs a pulsed voltage having a peak voltage of V_{bk} and a period of 2 ▪ D_{cmp} + (T_{tS1} —T_{S2}) via the output terminal OUT.

Next, two normal operating conditions of the neuron element 10A when the constant current i_{IN} = I is inputted to the input terminal IN at the time t = 0 will be described.

The first normal operating condition is that the measured voltage v_{A} at the time t = T_{S1} (= Vₚₖ) does not exceed the source voltage V_{DD}. That is, the first normal operating condition is given by Equation (1).

$${\text{V}}_{\text{DD}} > {\text{V}}_{\text{pk}} = {\text{V}}_{\text{th}} + \left(\text{I} \cdot {\text{D}}_{\text{Cmp}}\right) / {\text{C}}_{\text{A}}$$

Here, the second term on the right-hand side of Equation (1) represents a ramping up of the measured voltage v_{A} due to the charges flowing into the capacitor C_{A} from the time t = T_{tS1} to the time t = T_{S1}.

As for the second normal operating condition, it is assumed that the delay period D_{cmp} becomes sufficiently long. At this time, it is assumed that the threshold voltage Vₜₕ is sufficiently lowered so that the peak voltage Vₚₖ of the capacitor C_{A} does not exceed the source voltage V_{DD}.

Consequently, however, in a situation in which the switches SWAs and SWBs are switched to SW1, or the capacitors C_{A} and C_{B} are connected in parallel, it could happen that the measured voltage v_{A} (= v_{B}) exceeds the threshold voltage Vₜₕ.

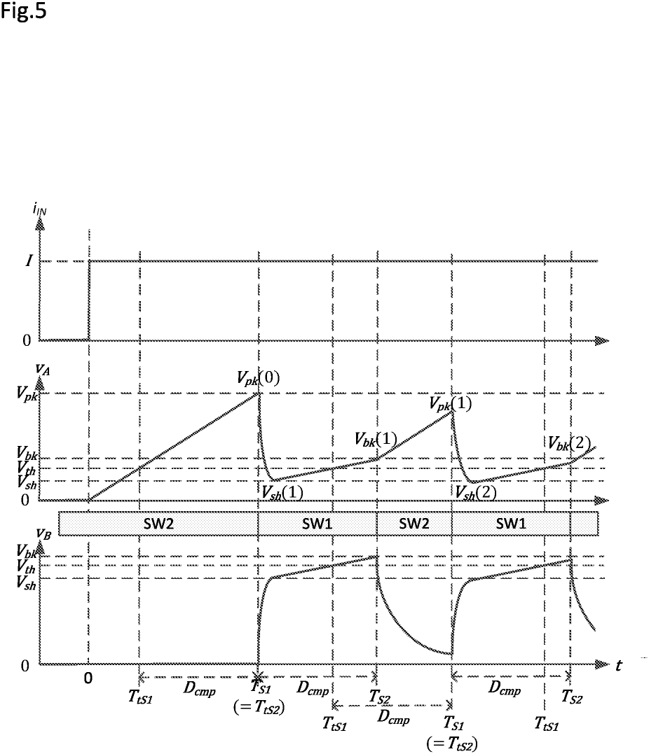

FIG. 5 is a timing chart showing temporal changes of respective signals in the neuron element 10A when the delay period D_{cmp} becomes longer.

In FIG. 5, even when the measured voltage v_{A} (= v_{B}) exceeds the threshold voltage Vₜₕ, a situation is shown in which the parallel connection state of the capacitors C_{A} and C_{B} is retained. Then, at the time t = T_{S2}, the capacitors C_{A} and C_{B} are separated. A value of the measured voltage v_{A} (= v_{B}) just before the separation is V_{bk}.

On the other hand, the comparator CMP outputs the selecting signal SW1 when the measured voltage v_{A} (= v_{B}) exceeds the threshold voltage Vₜₕ (at a time t = T_{tS1}), even when the parallel connection of the capacitors C_{A} and C_{B} is retained. Then, at a time t = T_{S1}, the switches SWA and SWB are switched to SW1.

Thus, at the switching from SW1 to SW2 and at that from SW2 to SW1 by the switches SWA and SWB, a period from a start of the SW switching operation to a time the SW switching is actually enabled overlaps. Specifically, in FIG. 5, a period from the time t = T_{tS1} to the time t = T_{S1} and a period from the time t = T_{tS2} to the time t = T_{S2} overlap each other from the time t = T_{tS1} to the time t = T_{S2}.

Consequently, a duration when the switch SWA and SWB are actually switched to SW2 is shortened. Then, because a discharging time of the capacitor C_{B} is shortened, the charges are not fully discharged from the capacitor C_{B} and thus there is residual charges in the capacitor C_{B}.

Subsequently, when the switches SWA and SWB are actually switched to SW1 and the capacitors C_{A} and C_{B} are connected in parallel, the residual charges are shared by the capacitors C_{A} and C_{B}. Consequently, a voltage Vₛₕ generated at the capacitors C_{A} and C_{B} ramps up by the residual charges.

Consequently, the time t = T_{tS1} at which the measured voltage v_{A} (= v_{B}) exceeds the threshold voltage Vₜₕ is moved forward (becomes earlier). However, the time t = T_{S2} does not change. This is because that the time t = T_{S2} is determined by the time t = T_{tS2}, which is a time at which the measured voltage v_{A} falls below the threshold voltage Vₜₕ after an abrupt drop of the measured voltage v_{A} caused by the switching of the switches SWA and SWB from SW2 to SW1.

Thus, the overlap period described above becomes longer, and the period in which the switches SWA and SWB are actually switched to SW2 is further shortened. In this way, the residual charges in the capacitor C_{B} gradually increases, and eventually, even if the capacitors C_{A} and C_{B} are connected in parallel, the voltage Vₛₕ generated at both capacitors does not fall below the threshold voltage Vₜₕ, and thus the neuron element 10A no more operates normally.

That is, the second normal operating condition is that the charges accumulated in the capacitor C_{B} are completely discharged while the switches SWA and SWB are actually switched to SW2.

Here, let a voltage generated at the capacitors C_{A} and C_{B} just before the parallel connection of the capacitors C_{A} and C_{B} is separated by the switching of SWA and SWB from SW1 to SW2 at k-th time be V_{bk}(k). The second normal operating condition is as shown in Equation (2).

$${\text{D}}_{\text{cmp}} - \text{-} \left(\left({\text{C}}_{\text{A}} {\text{+C}}_{\text{B}}\right) ⋅ \left({\text{V}}_{\text{bk}} \left(\text{k}\right) - \text{-} {\text{V}}_{\text{th}}\right)\right) \text{/} \text{I} > {τ}_{2}$$

Here, the second term on the left-hand side of Equation (2) corresponds to a duration from a time at which the measured voltage v_{A} (= v_{B}) exceeds the threshold voltage Vₜₕ to a time at which the measured voltage reaches V_{bk}(k), that is, it is a period from the time t = T_{tS1} to the time t = T_{S2} shown in FIG. 5. Furthermore, τ₂ is a time constant of a discharging circuit composed of the capacitor C_{B} and the resistive load R as described above, and is expressed by Equation (3).

$${τ}_{2} = \text{R} ⋅ {\text{C}}_{\text{B}}$$

Incidentally, the voltage V_{bk}(k) converges to a predetermined value while oscillating each time as a number of switching times of SWA and SWB increases, with a first voltage V_{bk}(1) shown in FIG. 5 as the largest value. On the other hand, a total amount of charges accumulated at a time of the measured voltage v_{A}(= v_{B}) = V_{bk}(1) is a sum of charges C_{A} ▪ Vₜₕ accumulated in the capacitor C_{A} at a time of the first t = T_{tS1} and charges 2 ▪ I ▪ D_{cmp} flowed during a subsequent duration of 2 ▪ D_{cmp}. Therefore, a relation between V_{bk}(k) and V_{bk}(1) is expressed by Equation (4).

$${\text{V}}_{\text{bk}} \left(\text{k}\right) ≦ {\text{V}}_{\text{bk}} \left(1\right) = \left({\text{C}}_{\text{A}} ⋅ {\text{V}}_{\text{th}} + 2 ⋅ \text{I} ⋅ {\text{D}}_{\text{cmp}}\right) / \left({\text{C}}_{\text{A}} \text{+} {\text{C}}_{\text{B}}\right)$$

On the other hand, the left-hand side of Equation (2) is minimized when V_{bk}(k) is a maximum value, or V_{bk}(1). Thus, when V_{bk}(k) in Equation (2) is set to V_{bk}(1), Equations (3) and (4) are substituted into Equation (2) and arranged, Equation (5) is obtained.

$$\left({\text{C}}_{\text{B}} ⋅ {\text{V}}_{\text{th}}\right) / \text{I} - \text{-} {\text{D}}_{\text{cmp}} > \text{R} ⋅ {\text{C}}_{\text{B}} \text{I} .$$

Suppose the most severe condition where a maximum instantaneous input current Iₘₐₓ is continuously inputted as the constant current. Then, Equations (1) and (5) provide the normal operating conditions among the device parameters for a stable operation of the neuron element 10A. Therefore, when Equations (1) and (5) are arranged in terms of Vₜₕ with I = Iₘₐₓ, Equation (6) is obtained.

$${\text{I}}_{max} ⋅ \left({\text{R+D}}_{\text{cmp}} {\text{/C}}_{\text{B}}\right) < {\text{V}}_{\text{th}} < {\text{V}}_{\text{DD}} - \text{-} \left({\text{I}}_{\text{max}} ⋅ {\text{D}}_{\text{cmp}}\right) / {\text{C}}_{\text{I}}$$

From Equation (6), an allowable setting range of the threshold voltage Vₜₕ is obtained. Furthermore, if an attention is paid to the leftmost side and the rightmost side of Equation (6), a constraint condition to be satisfied by the delay period D_{cmp} is expressed by Equation (7).

$${\text{D}}_{\text{cmp}} < \left({\text{C}}_{\text{A}} ⋅ {\text{C}}_{\text{B}}\right) / \left({\text{C}}_{\text{A}} + {\text{C}}_{\text{B}}\right) \left({\text{V}}_{\text{DD}} / {\text{I}}_{\text{m-x}} \text{I} \text{R}\right)$$

Equations (6) and (7) provide the normal operating conditions that the threshold voltage Vₜₕ and the delay period D_{cmp} should respectively satisfy in order for the neuron element 10A to operate normally, assuming the maximum instantaneous input current to be Iₘₐₓ.

Next, a second embodiment will be described. The same portions as those of the first embodiment are denoted by the same reference numerals, and repetitive descriptions thereof are omitted.

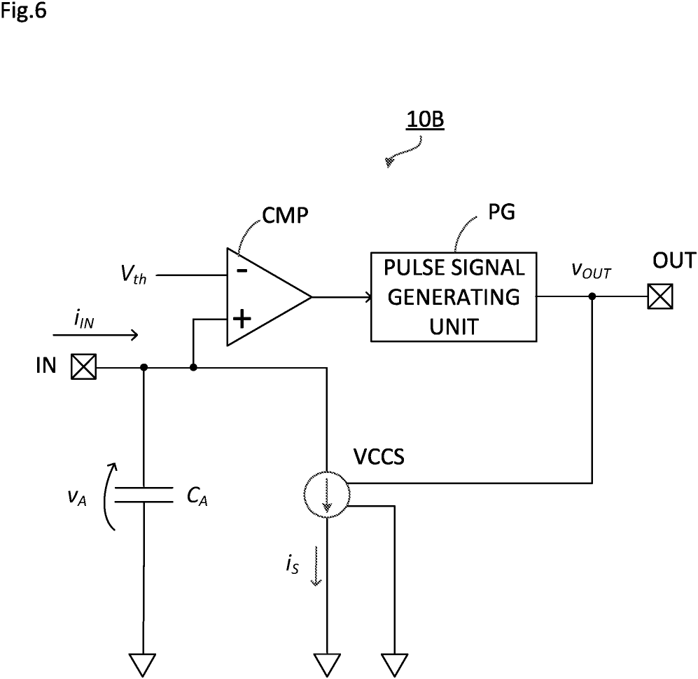

FIG. 6 is a circuit diagram showing a configuration of a neuron element 10B according to the second embodiment. The neuron element 10B is an exemplary configuration of the neuron element 10 shown in FIG. 1.

The neuron element 10B includes a capacitor C_{A}, a comparator CMP, a pulse signal generating unit PG, and a voltage controlled current source VCCS. One terminal of the capacitor C_{A} is connected to an input terminal IN, and the other terminal thereof is grounded.

The comparator CMP measures an amount of charges accumulated in the capacitor C_{A} as a voltage of the input terminal IN (= a voltage generated at the capacitor C_{A}), and determines whether the voltage being measured (the measured voltage v_{A}) exceeds a predetermined threshold voltage Vₜₕ. The comparator CMP supplies a high-level signal (H-signal) to the pulse signal generating unit PG when the measured voltage v_{A} exceeds the threshold voltage Vₜₕ, and supplies a low-level signal (L-signal) to the pulse signal generating unit PG when the measured voltage v_{A} does not exceed the threshold voltage Vₜₕ.

The pulse signal generating unit PG generates a pulse signal that is a rectangular wave with its duty ratio α (0 < α < 1) when the H-signal is supplied from the comparator CMP. On the other hand, the pulse signal generating unit PG does not generate the pulse signal when the L-signal is supplied from the comparator CMP. The pulse signal generated by the pulse signal generating unit PG is outputted to an outside via an output terminal OUT, and is also supplied to the voltage controlled current source VCCS.

The voltage controlled current source VCCS is connected in parallel with the capacitor C_{A}. Specifically, a current input terminal of the voltage controlled current source VCCS is connected to the input terminal IN. Its current output terminal is grounded. Then, the voltage controlled current source VCCS controls the current flowing from the current input terminal to the current output terminal based on the pulse signal generated by the pulse signal generating unit PG.

Specifically, the voltage controlled current source VCCS forcibly causes the constant current iₛ = I_{F} to flow in response to a high-level of the pulse signal generated by the pulse signal generating unit PG, and interrupts the current in response to a low-level of the pulse signal.

When the voltage controlled current source VCCS forces a constant current is = I_{F} and the constant current I_{F} is greater than the current coming from the input terminal IN, charges are discharged from the capacitor C_{A} connected to the input terminal IN and the measured voltage v_{A} of the capacitor C_{A} drops. When the voltage controlled current source VCCS interrupts the constant current I_{F}, all the current from the input terminal IN flows into the capacitor C_{A}, and the measured voltage v_{A} of the capacitor C_{A} ramps up.

The other terminal of the capacitor C_{A} and the current output terminal of the voltage controlled current source VCCS may be equipotential, and are not limited to be grounded as shown in the present embodiment.

Here, the pulse signal generating unit PG does not initiate or halt the pulse signal generation operation as soon as a ramping up measured voltage v_{A} exceeds a threshold voltage Vₜₕ or a dropping measured voltage v_{A} falls below the threshold voltage Vₜₕ. That is, there is a predetermined delay D_{cmp} from a time when the ramping up or dropping of the measured voltage v_{A} exceeds or falls below the threshold voltage Vₜₕ to a time when the pulse signal generating unit PG actually starts or stops the operation.

Therefore, the measured voltage v_{A} continues to ramp up from the time when the threshold voltage Vₜₕ is exceeded until the delay period D_{cmp} elapses, and drops when the operation of the pulse signal generating unit PG starts after the delay period D_{cmp} elapses and the voltage controlled current source VCCS discharges charges from the capacitor C_{A} in conjunction therewith.

The same is true when the measured voltage v_{A} of the capacitor C_{A} falls below the threshold voltage Vₜₕ. That is, the measured voltage v_{A} continues to drop from a time when it falls below the threshold voltage Vₜₕ until the delay period D_{cmp} elapses. The operation of the pulse signal generating unit PG then stops after the delay period D_{cmp} elapses, and the measured voltage v_{A} ramps up when the voltage controlled current source VCCS stops discharging the charges from the capacitor C_{A} in conjunction therewith.

The delay period D_{cmp} is a total sum of an interconnect delay, an operation delay of the pulse signal generating unit PG, a delay caused by the comparator CMP, and the like. In particular, the delay caused by the comparator CMP is determined from its output-capacitance Cₒᵤₜ, its transconductance gₘ and so on. Thus, by designing them appropriately, the delay period D_{cmp} is optimized.

When a signal is inputted from an outside, the neuron element 10B configured as described above operates as follows.

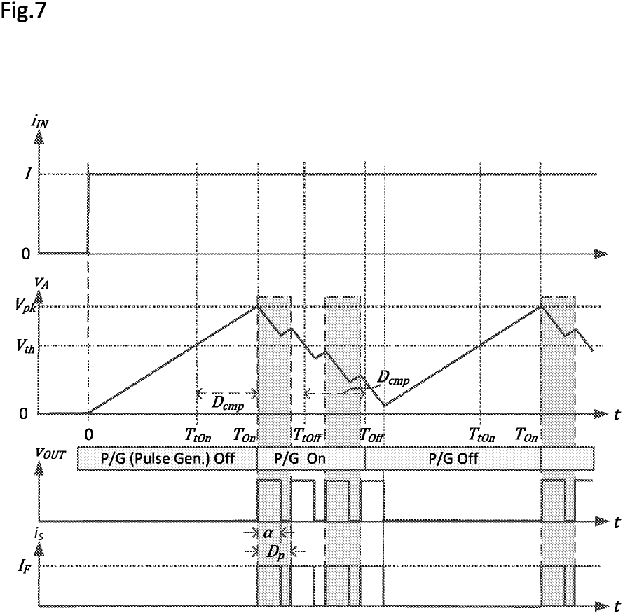

FIG. 7 is a timing chart showing temporal changes of respective signals in the neuron element 10B. In its initialization, charges accumulated in the capacitor C_{A} shown in FIG. 6 are zero. Therefore, the measured voltage v_{A} of the capacitor C_{A} is 0. Since the measured voltage v_{A} is lower than the threshold voltage Vₜₕ, the comparator CMP outputs the L-signal, and the operation of the pulse signal generating unit PG is stopped.

In FIG. 7, at a time t = 0, a constant current i_{IN} = I is inputted to the input terminal IN. In practice, however, a current input to the input terminal IN is not constant. Details of normal operating conditions of the neuron element 10B in the present embodiment will be described later.

When the constant current i_{IN} = I is inputted to the input terminal IN, the charges are accumulated in the capacitor C_{A}, and the measured voltage v_{A} of the capacitor C_{A} gradually ramps up.

At a time t = T_{tOn}, when the measured voltage v_{A} exceeds the threshold voltage Vₜₕ, the output signal of the comparator CMP switches from the L-signal to the H-signal. Consequently, the pulse signal generating unit PG initiates the pulse signal generation operation. When the pulse signal is supplied from the pulse signal generating unit PG, the voltage controlled current source VCCS forcibly causes the constant current iₛ = I_{F} to flow in response to the high-level signal (see a case when a time t = T_{On} described later). As a consequence, the charges are discharged from the capacitor C_{A} and the measured voltage v_{A} drops.

However, as described above, the pulse signal generating unit PG does not operate immediately even when the measured voltage v_{A} exceeds the threshold voltage Vₜₕ. A time t at which the pulse signal generating unit PG starts the pulse signal generation operation is t = Ton after the delay period D_{cmp} has elapsed from the time t = T_{tOn}.

That is, in a period from the time t = T_{tOn} to the time t = T_{On}, the charges are continuously accumulated in the capacitor C_{A}. As a result, the measured voltage v_{A} ramps up as it is even if it exceeds the voltage threshold voltage Vₜₕ, and reaches a peak voltage Vₚₖ just before the time t = T_{On}.

At the time t = T_{On}, when the pulse signal generating unit PG starts the pulse signal generation operation, the voltage controlled current source VCCS forcibly causes the constant current iₛ = I_{F} to flow in response to the high-level of the pulse signal supplied from the pulse signal generating unit PG. As a consequence, the charges are discharged from the capacitor C_{A} and the measured voltage v_{A} drops.

On the other hand, the voltage controlled current source VCCS cuts off the current flow in response to the low-level of the pulse signal. At this time, the charges are accumulated in the capacitor C_{A} and the measured voltage v_{A} ramps up again. The ramp-up speed (slope) of the measured voltage v_{A} at this time is a same as the ramp-up speed of the measured voltage v_{A} from the time t = 0 to the time t = T_{tOn} (═ I/C_{A}).

As a result, during the generation of the pulse signal by the pulse signal generating unit PG, the measured voltage v_{A} drops on the average while periodically repeating the dropping and the ramping-up.

At a time t = T_{tOff}, the measured voltage v_{A} falls below the threshold voltage Vₜₕ. At this time, the signal outputted from the comparator CMP and supplied to the pulse signal generating unit PG is switched from the H-signal to the L-signal. Then, the pulse signal generating unit PG stops the pulse signal generation operation. Consequently, the voltage controlled current source VCCS cuts off the current flow.

However, as described above, the pulse signal generating unit PG does not stop as soon as the measured voltage v_{A} falls below the threshold voltage Vₜₕ. A time t at which the pulse signal generating unit PG stops the pulse signal generation operation is t = Toff after the delay period D_{cmp} has elapsed from the time t = T_{tOff}. That is, in a period from the time t = T_{tOff} to the time t = T_{Off}, the charges are continuously discharged from the capacitor C_{A}. Consequently, the measured voltage v_{A} drops as is, even if it falls below the threshold voltage Vₜₕ.

Note that, because of its nature, even if the L-signal is supplied from the comparator CMP during the pulse signal generation operation, the pulse signal generating unit PG generates a complete pulse signal for one period and then stops, without immediately interrupting the generation operation.

At the time t = Toff, the operation of the pulse signal generating unit PG stops, the voltage controlled current source VCCS stops and interrupts the current flow is. Then, a constant current i_{IN} = I from the input terminal IN accumulates the charges in the capacitor C_{A}, and the measured voltage v_{A} of the capacitor C_{A} ramps up again.

Thereafter, at a second time t = T_{tOn}, the measured voltage v_{A} again exceeds the threshold voltage Vₜₕ. At a second time t = T_{On} after the second time t = T_{tOn} and the delay period D_{cmp}, the pulse signal generating unit PG and the voltage controlled current source VCCS resume their operations. Then, the above-described operations are repeated.

As described above, when the constant current i_{IN} = I is inputted to the input terminal IN, the neuron element 10B according to the second embodiment intermittently outputs a pulse signal having a predetermined voltage, a period Dₚ and a rectangular wave with a duty ratio α, via the output terminal OUT.

Next, two normal operating conditions of the neuron element 10B will be described.

In a first normal operating condition, consider a case where a constant current i_{IN} = I is inputted to the input terminal IN at the time t = 0. Here, a maximum instantaneous input current I = Iₘₐₓ is used instead of the constant current i_{IN} = I to derive the normal operating condition.

As described above, in order for the measured voltage v_{A} of the capacitor C_{A} to continue to drop on average, the amount of charges discharged from the capacitor C_{A} by the voltage controlled current source VCCS needs to be larger than the amount of charges flowing into the capacitor C_{A} by the constant current i_{IN} = Iₘₐₓ.

Consider a pulse signal for one cycle generated by the pulse signal generating unit PG immediately after the time t = T_{On}.

In the one cyclic period of the pulse signal, a total amount of charges flowed into the capacitor C_{A} is given by Dₚ ▪ Iₘₐₓ because one cyclic period of the pulse signal is Dₚ. In the one cyclic period, a total amount of charges discharged from the capacitor C_{A} by the voltage controlled current source VCCS is given by α ▪ Dₚ ▪ I_{F} because an operation time of the voltage controlled current source VCCS is α ▪ Dₚ. Since the latter is larger than the former, the first normal operating condition is expressed by Equation (8).

$${\text{I}}_{\text{F}} > 1 / \text{α} ⋅ {\text{I}}_{max}$$

On the other hand, if the voltage controlled current source VCCS forcibly discharges the charges from the capacitor C_{A} even when the amount of charges accumulated in the capacitor C_{A} becomes zero, it is assumed that the voltage controlled current source VCCS does not operate normally. Therefore, the second normal operating condition is a condition for avoiding such the unnormal operation.

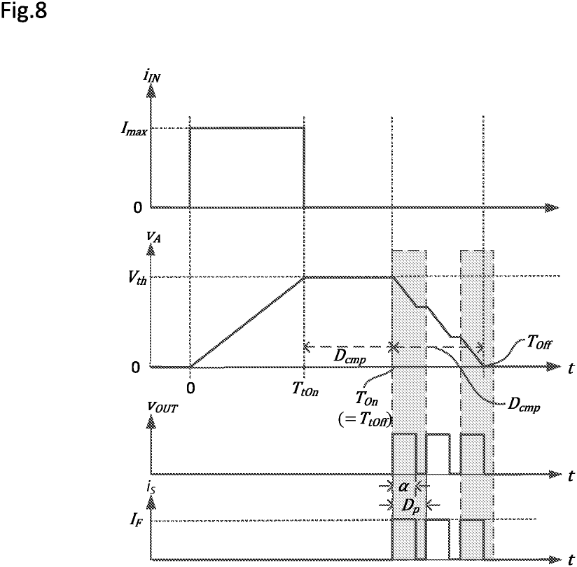

FIG. 8 is a timing chart showing temporal changes of respective signals in the neuron element 10B when it is most likely to cause a condition that does not operate normally.

In FIG. 8, at the time t = 0, the constant current i_{IN} = Iₘₐₓ is inputted to the input terminal IN. Thus, the charges are accumulated in the capacitor C_{A} and the measured voltage v_{A} of the capacitor C_{A} ramps up at a rate Iₘₐₓ/C_{A}.

At the time t = T_{tOn}, suppose that the constant current i_{IN} = Iₘₐₓ stops immediately after the measured voltage v_{A} exceeds the threshold voltage Vₜₕ. Consequently, the amount of accumulated charges in the capacitor C_{A} remains constant. Thereafter, when the pulse signal generating unit PG starts the pulse signal generation operation and the voltage controlled current source VCCS responds to the pulse signal generation operation by causing the constant current iₛ = I_{F} to flow, the charges are forcibly discharged from the capacitor C_{A}.

However, the voltage controlled current source VCCS actually starts the operation at which a time t becomes t = T_{On} after the delay period D_{cmp} elapses from the time t = T_{tOn}, and after the pulse signal generating unit PG starts the pulse signal generation operation. Here, just before the time t = Ton, the amount of charges C_{A} ▪ Vₜₕ is accumulated in the capacitor C_{A}.

At the time t = T_{On}, the voltage controlled current source VCCS causes the constant current iₛ = I_{F} to flow in response to the high-level of the pulse signal supplied from the pulse signal generating unit PG. Consequently, in one cyclic period of the pulse signal, the amount of charges α ▪ D ₚ ▪ I_{F} is forcibly discharged from the capacitor C_{A}, and the measured voltage v_{A} drops by α ▪ D p ▪ I_{F}/C_{A}. The voltage controlled current source VCCS also cuts off the current flow in response to the low-level of the pulse signal. At this time, no charge is discharged from the capacitor C_{A}, and the measured voltage v_{A} does not change.

As described above, when the pulse signal is at the high-level, the measured voltage v_{A} drops, and when the pulse signal is at the low-level, the measured voltage v_{A} does not drop and remains constant. Therefore, as shown in FIG. 8, after the time t = Tₒₙ, the measured voltage v_{A} periodically and intermittently drops.

On the other hand, as described above, immediately before the time t = T_{On}, the amount of charges C_{A} ▪ Vₜₕ is accumulated in the capacitor C_{A}. Then, since the charges are discharged from the capacitor C_{A} by the pulse signal immediately after the time t = T_{On}, the measured voltage v_{A} immediately falls below the threshold voltage Vₜₕ and the signal provided from the comparator CMP to the pulse signal generating unit PG switches from the H-signal to the L-signal. Let a time at this time be t = T_{toff}.

However, as described above, the pulse signal generating operation of the pulse signal generating unit PG is not stopped immediately even if the measured voltage v_{A} falls below the threshold voltage Vₜₕ. A time t at which the pulse signal generating unit PG stops the operation is t = T_{Off} after the delay period D_{cmp} has elapsed from the time t = T_{tOff}. That is, from the time t = T_{tOff} to the time t = T_{Off}, charges are periodically and intermittently discharged from the capacitor C_{A} by the voltage controlled current source VCCS. In other words, the drop of the measured voltage v_{A} described above continues until the time t = T_{Off}.

Suppose that the pulse signal supplied to the voltage controlled current source VCCS goes through n periods and the measured voltage v_{A} drops to a near-zero value. At this time, a total amount of charges emitted from the capacitor C_{A} is n ▪ α ▪ Dₚ ▪ I_{F}. On the other hand, as mentioned previously, an amount of charges accumulated in the capacitor C_{A} before the pulse signal generating unit PG initiates the pulse signal generation operation is C_{A} ▪ Vₜₕ.

The total amount of charge discharged from the capacitor C_{A} must not exceed the amount of charges accumulated in the capacitor C_{A}. That is, it is necessary to satisfy Equation (9).

$$\left(\text{n} ⋅ \text{α} ⋅ {\text{D}}_{\text{p}} ⋅ {\text{I}}_{\text{F}}\right) / {\text{C}}_{\text{A}} < {\text{V}}_{\text{th}} < \text{} {\text{V}}_{\text{DD}}$$

Here, an inequality on the right-hand side of Equation (9) indicates that an upper limit of the threshold voltage Vₜₕ is given by the source voltage V_{DD}.

Next, a relation between the discharging period and the delay period D_{cmp} by a continuous operation of the voltage controlled current source VCCS will be described.

In FIG. 8, if the delay period D_{cmp} is shorter than the discharging period, a position of the time t = Toff moves leftward, and as a result, the charges accumulated in the capacitor C_{A} does not become zero. Thus, the neuron element 10B operates normally.

Conversely, if the delay period D_{cmp} is longer than the discharging period, the charges are discharged beyond the amount of charges accumulated in the capacitor C_{A}. Therefore, the neuron element 10B does not operate normally. Thus, the condition to be satisfied by the delay period D_{cmp} is given by Equation (10) when the cyclic period Dₚ of the pulse signal supplied to the voltage controlled current source VCCS is sufficiently smaller than the delay period D_{cmp}.

$${\text{D}}_{\text{cmp}} ≦ \text{n} ⋅ {\text{D}}_{\text{p}}$$

In Equation (10), n is given by Equation (11) where the largest integer less than or equal to x for a real number x is represented by [x] using the Gaussian symbol [].

$$\text{n} = \left[\left({\text{C}}_{\text{A}} ⋅ {\text{V}}_{\text{th}}\right) / \left(\text{α} ⋅ {\text{D}}_{\text{p}} ⋅ {\text{I}}_{\text{F}}\right)\right]$$

Substituting Equation (11) into Equation (10), and further considering the inequality on the right-hand side of Equations (8) and (9), Equation (10) becomes Equation (12).

$${\text{D}}_{\text{cmp}} < {\text{C}}_{\text{A}} ⋅ {\text{V}}_{\text{DD}} / {\text{I}}_{max}$$

In addition, when Equation (10) is substituted into the inequality on the left-hand side of Equation (9), and Equation (8) is further considered, Equation (9) becomes Equation (13).

$$\left({\text{D}}_{\text{cmp}} ⋅ {\text{I}}_{max}\right) / {\text{C}}_{\text{A}} < {\text{V}}_{\text{th}} < {\text{V}}_{\text{DD}}$$

That is to say, when a maximum instantaneous input current is assumed to be Iₘₐₓ, Equations (12) and (13) are the normal operating conditions both the delay period D_{cmp} and the threshold voltage Vₜₕ need to respectively satisfy in order to normally operate the neuron element 10B.

The pulse signal generating unit PG may be designed so as to generate a pulse signal having: a duty ratio α with which the constant current i_{S} = I_{F} controlled by the voltage controlled current source VCCS is set so as to satisfy Equation (8); and a cyclic period Dₚ which is set so as to satisfy Equation (10) using a desired n.

Incidentally, in the first and second embodiments, a case has been described in which a reference potential of the capacitor C_{A} is set to 0V, a current flows into the capacitor C_{A}, and the measured voltage v_{A} generated at the capacitor C_{A} ramps up toward the source voltage V_{DD}. However, the present invention is not limited to these embodiments.

For example, as will be described later, while the reference potential of the capacitor C_{A} remains at 0V, the current may flow out of the capacitor C_{A}, and the measured voltage v_{A} generated at the capacitor C_{A} may fall toward a negative source voltage -V_{DD}.

Furthermore, the source voltage V_{DD} may be used as the reference potential of the capacitor C_{A}, and as a result of the current flowing into the capacitor C_{A}, the measured voltage v_{A} generated at the capacitor C_{A} may fall toward 0V.

Next, a third embodiment will be described. It should be noted that the same reference numerals are assigned to the same portions as those in the above-described embodiments, and repetitive descriptions thereof are omitted.

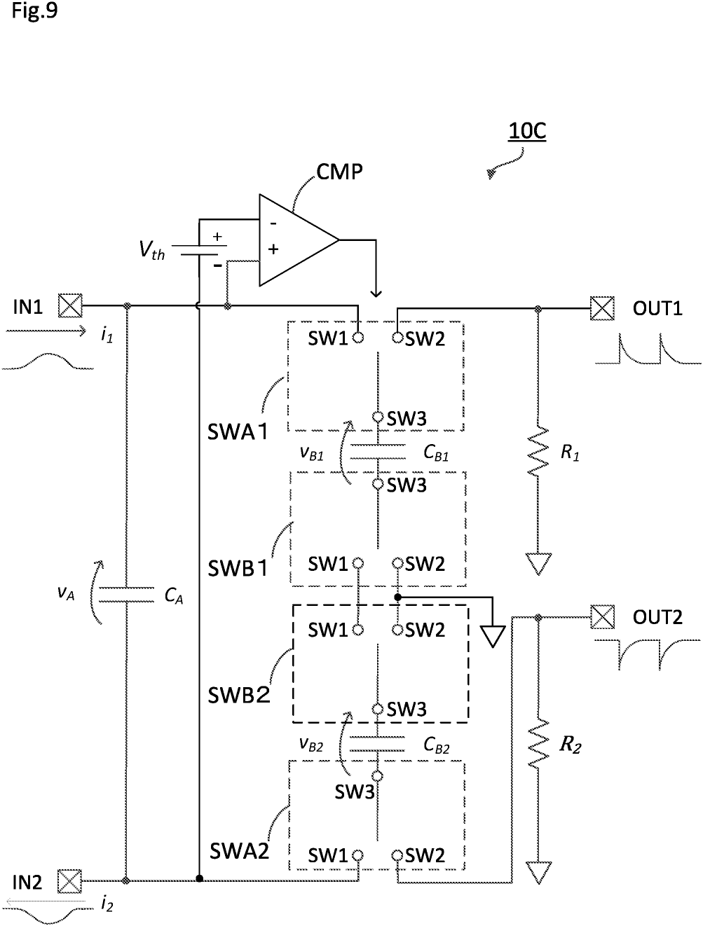

FIG. 9 is a circuit diagram showing an exemplary configuration of a neuron element 10C according to the third embodiment. The neuron element 10C has a circuit corresponding to the neuron element 10A shown in FIG. 3 and a circuit obtained by inverting the circuit corresponding to the neuron element 10A. That is, the neuron element 10C includes capacitors C_{A}, C_{B1} and C_{B2}, a comparator CMP, switches SWA1, SWB1, SWA2 and SWB2, and resistive loads R₁ and R₂.

One terminal of the capacitor C_{A} is connected to an input terminal IN1, and the other terminal is connected to an input terminal IN2. That is, the capacity C_{A} is not grounded. Therefore, when a current flows from the input terminal IN1 to the capacitor C_{A}, a current having a magnitude equal to that flowing into the capacitor C_{A} flows out from the input terminal IN2. Therefore, a voltage v_{A} based on a potential of the input terminal IN2 is generated at both terminals of the capacity C_{A}. In this way, the capacitor C_{A} is integrated into one in order to suppress the number of the components.

Each one terminal of the capacitors C_{B1} and C_{B2} is connected to a terminal SW3 of the switches SWA1 and SWA2, respectively. The other terminal of the capacitors C_{B1} and C_{B2} is connected to the terminals SW3 of the switches SWB1 and SWB2, respectively.

Each terminal SW1 of the switches SWA1 and SWA2 is connected to the input terminal IN1 and IN2, respectively. Each terminal SW1 of the switches SWB1 and SWB2 is connected to each other.

A terminal SW2 of the switch SWA1 is connected to the resistive load R₁ and an output terminal OUT1. A terminal SW2 of the switch SWA2 is connected to the resistive load R₂ and an output terminal OUT2. Each terminal SW2 of the switches SWB1 and SWB2 is grounded.

One terminal of the resistive load R₁ is connected to the terminal SW2 of the switch SWA1 and the output terminal OUT1. The other terminal of the resistive load R₁ is grounded. One terminal of the resistive load R₂ is connected to the terminal SW2 of the switch SWA2 and the output terminal OUT2. The other terminal of the resistive load R₂ is grounded.

An inverted input terminal of the comparator CMP is connected to a positive terminal of a constant voltage source Vₜₕ which supplies a predetermined reference voltage Vₜₕ. A noninverted input terminal of the comparator CMP is connected to the input terminal IN1. A negative terminal of the constant voltage source Vₜₕ is connected to the input terminal IN2. Then, the constant voltage source Vₜₕ supplies, to the inverted input terminal of the comparator CMP, a reference voltage Vₜₕ based on a potential of the input terminal IN2 as a threshold voltage Vₜₕ.

The comparator CMP measures an amount of charges accumulated in the capacitor C_{A} as a voltage of the input terminal IN1 based on a potential of the input terminal IN2 (a voltage of the capacitor C_{A}), and determines whether or not the voltage being measured (the measured voltage v_{A}) exceeds the predetermined threshold voltage Vₜₕ. The comparator CMP supplies a selecting signal SW1 to the switches SWA1, SWB1, SWA2 and SWB2 when the measured voltage v_{A} exceeds the threshold voltage Vₜₕ, and supplies a selecting signal SW2 to the switches SWA1, SWB1, SWA2 and SWB2 when the measured voltage v_{A} does not exceed the threshold voltage Vₜₕ.

The switches SWA1, SWB1, SWA2 and SWB2 switch as follows when the selecting signal is supplied from the comparator CMP. That is, the switches SWA1, SWB1, SWA2 and SWB2, when the selecting signal SW1 is supplied, conduct between the terminals SW1 and SW3 (switched to SW1). On the other hand, the switches SWA1, SWB1, SWA2 and SWB2, when the selecting signal SW2 is supplied, conduct between the terminals SW2 and SW3 (switched to SW2).

Therefore, when the selecting signal SW1 is supplied to the switches SWA1, SWB1, SWA2 and SWB2, the capacitor C_{A} and a serially connected capacitors C_{B1} and C_{B2} are connected in parallel. On the other hand, when the selecting signal SW2 is supplied to the switches SWA1, SWB1, SWA2 and SWB2, the capacitors C_{B1} and C_{B2} are respectively connected to the resistive load R₁ and R₂ in parallel. The charges accumulated in the capacitors C_{B1} and C_{B2} are discharged through the resistive load R₁ and R₂, respectively.

The terminals SW2 of the switches SWB1 and SWB2, and the other terminals of the resistive loads R₁ and R₂ may be equipotential, and are not limited to be grounded as shown in the present embodiment.

When signals are inputted from an outside, the neuron element 10C configured as described above operates as follows. Here, at its initial state, charges accumulated in the capacitors C_{A}, C_{B1} and C_{B2} are zero. Therefore, the measured voltage v_{A} of the capacitor C_{A} is 0. Since the measured voltage v_{A} is below the threshold voltage Vₜₕ, all switches SWA1, SWB1, SWA2 and SWB2 have switched SW2. Thus, the capacitors C_{B1} and C_{B2} are separated from the capacitor C_{A}.

Now, when a constant current i₁ = I is inputted to the input terminal IN1, a constant current i₂ = I equivalent to the constant current i₁ flows out from the input terminal IN2 and the charges are accumulated in the capacitors C_{A}, and the measured voltage v_{A} at the capacitor C_{A} gradually ramps up.

If the measured voltage v_{A} exceeds the threshold voltage Vₜₕ, the comparator CMP supplies the selecting signal SW1 to the switches SWA1, SWB1, SWA2 and SWB2. Consequently, the switches SWA1, SWB1, SWA2 and SWB2 initiate their switching operations from SW2 to SW1.

However, as described in the first embodiment, the switching operations from SW2 to SW1 for the switches SWA1, SWB1, SWA2 and SWB2 are not executed immediately. A time t at which SW2 is switched to SW1 is t = T_{S1} which is a time after a delay period D_{cmp} elapses from a time t = T_{tS1} at which the measured voltage v_{A} exceeds the threshold voltage Vₜₕ.

That is, in a period from the time t = T_{tS1} to the time t = T_{S1}, the charges are continuously accumulated in the capacitor C_{A}. As a result, the measured voltage v_{A} ramps up as it is, even if it exceeds the threshold voltage Vₜₕ, and peaks just before the time t = T_{S1}.

At the time t = T_{S1}, when the switches SWA1, SWB1, SWA2 and SWB2 are switched from SW2 to SW1, the capacitors C_{A} and the serially connected capacitors C_{B1} and C_{B2} are connected in parallel. Then, the charges accumulated in the capacitor C_{A} flow into the serially connected capacitors C_{B1} and C_{B2}. Therefore, the measured voltage v_{A} of the capacitor C_{A} drops exponentially. Voltages v_{B1} and v_{B2} generated at the respective capacitors C_{B1} and C_{B2} ramp up exponentially.

However, suppose parasitic resistances r among the capacitors C_{A}, C_{B1} and C_{B2} be small enough, and a time constant τ₁ among the capacitors C_{A}, C_{B1} and C_{B2} be negligible compared with the delay period D_{cmp}. As a result, at an instant when a time t exceeds T_{S1}, a part of the charges accumulated in the capacitor C_{A} flows into the capacitors C_{B1} and C_{B2}. Then, the voltage v_{A} generated at the capacitor C_{A} and, a voltage generated at the serially connected capacitors C_{B1} and C_{B2} (= v_{B1} + v_{B2}) become equal.

At this time, the measured voltage v_{A} (= v_{B1} + v_{B2}) is lower than the threshold voltage Vₜₕ. For this reason, the comparator CMP provides the selecting signal SW2 to the switches SWA1, SWB1, SWA2 and SWB2. The switches SWA1, SWB1, SWA2 and SWB2 start their switching operations from SW1 to SW2.

When the delay period D_{cmp} elapses from a time when the measured voltage v_{A} falls below the threshold voltage Vₜₕ, the switches SWA1, SWB1, SWA2 and SWB2 are switched from SW1 to SW2. Thus, the serially connected capacitors C_{B1} and C_{B2} are separated from the capacitor C_{A}. The charges accumulated in the capacitors C_{B1} and C_{B2} are then discharged through the respective resistive loads R₁ and R₂.

The voltages v_{B1} and v_{B2} generated at the respective capacitors C_{B1} and C_{B2} drop abruptly according to exponential functions having respective time constants τ₂₁ (= R₁ · C_{B1}) and τ₂₂ (= R₂ · C_{B2}). The voltages v_{B1} and v_{B2} are supplied as pulse signals to external loads via the output terminals OUT1 and OUT2, respectively.

Here, let C_{A}, C_{B1} and C_{B2} be respective capacitances of the capacitors C_{A}, C_{B1} and C_{B2}, and R₁ and R₂ be respective resistances of the resistive loads R₁ and R₂. At this time, Equations (14) and (15) are respectively satisfied between those device parameters and, the capacitance C_{B} of the capacitor C_{B} and the resistance R of the resistive load R, used in the first embodiment.

$${\text{C}}_{\text{B1}} = {\text{C}}_{\text{B2}} = 2 ⋅ {\text{C}}_{\text{B}}$$

$${\text{R}}_{\text{1}} = {\text{R}}_{\text{2}} = \text{R/2}$$

If Equations (14) and (15) are satisfied, an upper half of the circuit shown in FIG. 9 (the capacitors C_{A} and C_{B1}, the comparator CMP and the resistive load R₁) is equivalent to the circuit shown in FIG. 3 (the capacitors C_{A} and C_{B}, the comparator CMP and the resistive load R). Furthermore, a lower half of the circuit shown in FIG. 9 (the capacitors C_{A} and C_{B2}, the comparator CMP and the resistive load R₂) is equivalent to that inverted polarity of the circuit shown in FIG. 3. That is, a signal output from the output terminal OUT2 is equivalent to that obtained by inverting a polarity of a signal output from the output terminal OUT1.

Consequently, the neuron element 10C can cancel effects of noises applied equally to the upper and the lower circuits compared to the case in FIG. 3, and thus can generate a lower noise, higher precision pulse signal.

Note that the present embodiment is not limited to the one based on the neuron element 10A in the first embodiment, and can be applied to the one based on the neuron element 10B in the second embodiment. That is, the present embodiment can be applied to all of the devices having the same functions as those of the neuron element 10 in FIG. 1.

Next, a fourth embodiment will be described. It should be noted that the same reference numerals are assigned to the same portions as those in the above-described embodiments, and repetitive descriptions thereof are omitted.

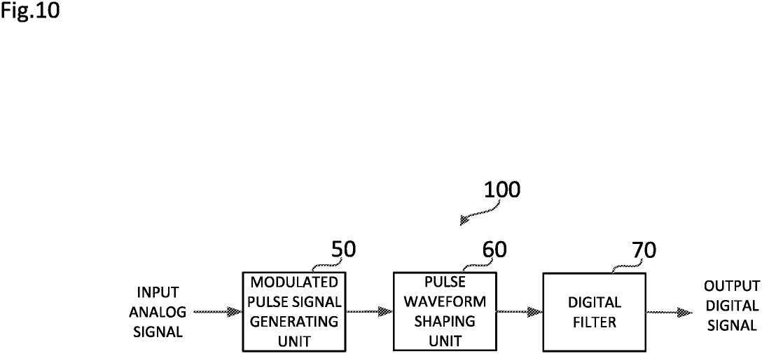

FIG. 10 is a block diagram showing a functional configuration of an A/D converter 100 according to the fourth embodiment. The A/D converter 100 includes a modulated pulse signal generating unit 50, a pulse waveform shaping unit 60, and a digital filter 70. The modulated pulse signal generating unit 50 has a same configuration as the neuron element 10 shown in FIG. 1.

If a pulse signal received from the modulated pulse signal generating unit 50 is not square, the pulse waveform shaping unit 60 shapes it and outputs it as a rectangular wave. The digital filter 70 is, for example, a pulse counter composed of a T-type flip-flop multistage connection. The digital filter 70, for the rectangular wave received from the pulse waveform shaping unit 60, for example, performs processing such as counting a number of the rectangular waves being received within a predetermined range on a time axis and converting the number into an n-bit output digital signal.

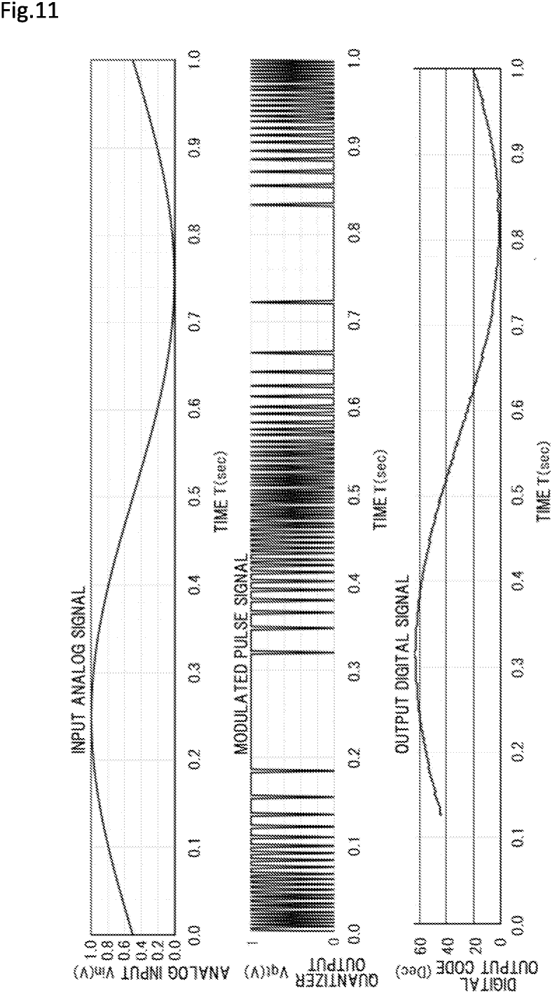

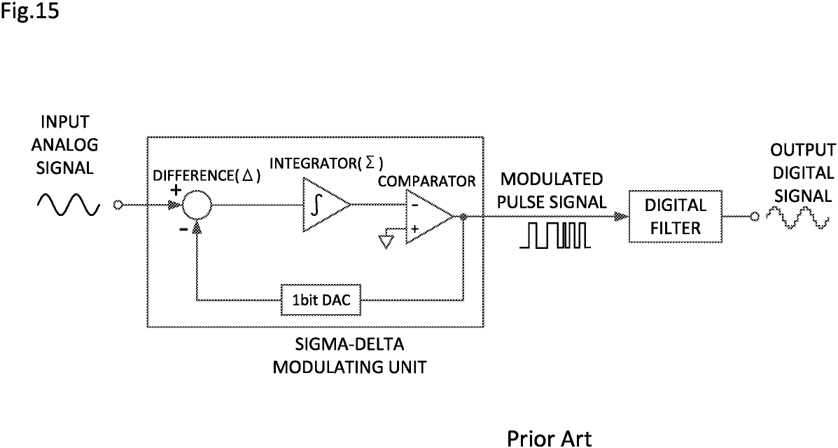

FIG. 11 is a set of wave diagrams respectively showing an input analog signal, a modulated pulse signal and an output digital signal, of a conventional sigma-delta A/D converter (e.g., shown in FIG. 15).

In FIG. 11, an upper input analog signal is a sine wave voltage signal with a frequency of 1 Hz and an amplitude of 0.5 V (0.0 V∼1.0 V). A waveform diagram in a middle row shows a 1-bit modulated pulse signal obtained by performing a sigma-delta modulation at a sampling frequency of 500 Hz for this input analog signal. A lower waveform diagram is an output digital signal as a result of the A/D conversion of the input analog signal obtained by performing a predetermined digital processing for this 1-bit modulated pulse signal in a subsequent digital filter.

As shown in the waveform diagram in the middle row of FIG. 11, in the conventional sigma-delta A/D converter, a pulse density near a reference amplitude of the input analog signal (0.5V in FIG. 11) is high. Thus, in the conventional sigma-delta A/D converter, when the amplitude of the input signal is set to-1.0 V~1.0 V, for example, the pulse density is highest in the vicinity of 0 V that is the reference value.

In other words, in the conventional sigma-delta A/D converter, even when there is little input analog signal (when the input analog signal is near the reference value (zero)), the high density pulse signal occurs. Therefore, there is a problem that a power is consumed unnecessarily even though there is almost no input analog signal.

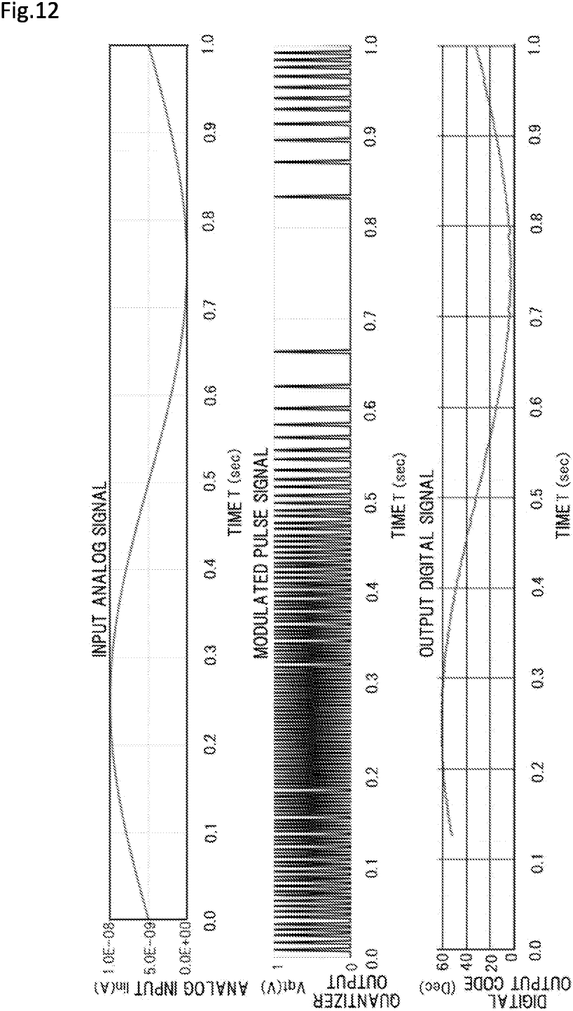

FIG. 12 is a set of wave diagrams respectively showing an input analog signal, a modulated pulse signal and an output digital signal, of the A/D converter 100 shown in FIG. 10.

In FIG. 12, an upper input analog signal is a sine wave current signal with a frequency of 1 Hz and an amplitude of 5 nA (0 nA to 10 nA). A waveform diagram in a middle row shows a 1-bit modulated pulse signal obtained by the modulated pulse signal generating unit 50 of the A/D converter 100 for this input analog signal. It should be noted that although the modulated pulse signal generating unit 50 originally performs an event-driven type operation which performs a processing passively only when there is an input signal, the present embodiment shows a result of performing a synchronous operation with a sampling frequency of 500 Hz in order to directly compare the present embodiment with the conventional sigma-delta A/D converter operating with the same sampling frequency. A lower waveform diagram is an output digital signal as a result of the AD-conversion of the input analog signal obtained by performing a predetermined digital processing for this 1-bit modulated pulse signal by the digital filter 70.

As shown in the waveform diagram in the middle row of FIG. 12, in the A/D converter 100, a pulse density when the input analog signal is near-zero is substantially reduced.

In other words, in the A/D converter 100, when there is almost no input analog signal, a power consumption can be suppressed by making a density of the pulse signal sparse depending on an amplitude of the input analog signal.

In the present embodiment, the A/D converter 100 is an example of an AD-converting of a sine wave current signal as the input analog signal, but it is not limited to such the example.

For example, as described above, the neuron element 10 shown in FIG. 1 originally functions as an event-driven type device that operates only when a signal is inputted. That is, because the neuron element 10, unlike a common synchronized processing, does not operate unnecessary circuitry when there is no input signal, it is possible to significantly suppress the power consumption.

Next, a fifth embodiment will be described. It should be noted that the same reference numerals are assigned to the same portions as those in the above-described embodiments, and repetitive descriptions thereof are omitted.

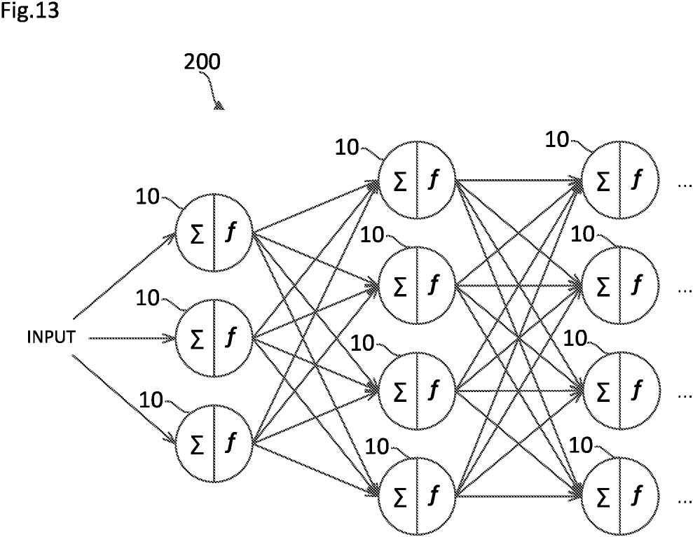

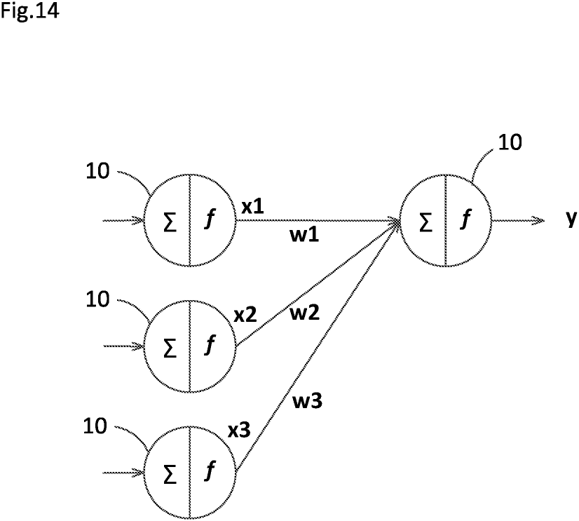

FIG. 13 is a diagram showing an exemplary configuration of a neural network 200 according to the fifth embodiment. The neural network 200 includes a plurality of the neuron element 10 configured in multiple stages. FIG. 14 is a diagram showing a relation between an output signal xᵢ of the neuron element 10 (i = 1, 2, 3) and a weighting coefficient wᵢ (i = 1, 2, 3).

An input signal of any neuron element 10 is a summation of a plurality of the neuron element 10 output signal xᵢ weighted by the weighting coefficient wᵢ. The input signal is accumulated in the charge accumulating unit 12 of the neuron element 10. Then, the neuron element 10 supplies the output signal to the neuron element 10 of a next stage through a processing shown in FIG. 2.

Note that the input signal of any neuron element 10 is not limited to the output signal of another neuron element 10, and may be a signal inputted externally (an external input signal). Also, the input signal of any neuron element 10 may be both the output signal of other neuron element 10 and the external input signal. Furthermore, the output signal and the external input signal may be a plurality or singular.

The output signal of any neuron element 10 is not limited to the input signal of another neuron element 10, and may be an output signal to an outside (an external output signal), or may be both the input signal to other neuron element 10 and the external output signal. Furthermore, the input signal and the external output signal may be a plurality or singular.

The neural network 200 configured as described above can realize a so-called deep learning by optimizing the weighting coefficient wᵢ based on teacher data prepared in advance for a desired purpose.

It should be noted that the present invention is not limited to the above-mentioned embodiments, and can be applied to those whose design is changed within a scope of the claims.

### REFERENCE SIGNS LIST

10, 10A, 10B, 10C Neuron elements
12 Charge accumulating unit
13 Discharging unit
14 Pulse signal generating unit
16 Controlling unit
20 Signal processing unit
50 Modulated pulse signal generating unit
70 Digital filter
100 A/D converter
200 Neural network
C_{A}, C_{B}, C_{B1}, C_{B2} capacitors
CMP comparator
PG pulse signal generating unit
R, R₁, R₂ resistive loads
SWA, SWA1, SWA2, SWB, SWB1, SWB2 Switches
VCCS Voltage controlled current source

1. A neuron element comprising:
a first charge accumulating unit configured to accumulate charges by an input signal;
a signal processing unit which, based on a condition when the charges accumulated in the first charge accumulating unit exceed a first predetermined amount of charges, is configured to:
discharge a second predetermined amount of charges from the first charge accumulating unit; and
generate a pulse signal,
wherein the signal processing unit performs a predetermined processing in relation to the second predetermined amount of charges and the pulse signal.

2. The neuron element according to claim 1,
wherein the signal processing unit comprises:
a pulse signal generating unit configured to generate the pulse signal, and
a discharging unit which, as the predetermined processing, is configured to discharge the second predetermined amount of charges from the first charge accumulating unit based on the pulse signal generated by the pulse signal generating unit.

3. The neuron element according to claim 2,
wherein the discharging unit is connected in parallel with the first charge accumulating unit and further comprises:
a constant current source configured to discharge the second predetermined amount of charges from the first charge accumulating unit by causing a predetermined current during a period in which the pulse signal is generated by the pulse signal generating unit; and
a determining unit configured to output an on signal based on the condition when the charges accumulated in the first charge accumulating unit is determined to exceed the first predetermined amount of charges, and
wherein the pulse signal generating unit is configured to generate the pulse signal with a predetermined duty ratio while the on signal is inputted to the pulse signal generating unit from the determining unit.

4. The neuron element according to claim 3,
wherein, when a maximum instantaneous input current of the input signal is Iₘₐₓ, a capacitance of the first charge accumulating unit is C_{A}, a threshold voltage for detecting the first predetermined amount of charges is Vₜₕ, a source voltage is V_{DD}, and a delay period, from a time when a voltage generated at the first charge accumulating unit exceeds the threshold voltage Vₜₕ to a time when the constant current source causes the predetermined current, is D_{cmp}, then D_{cmp} is less than C_{A} · V_{DD}/Iₘₐₓ.

5. The neuron element according to claim 1,
wherein the signal processing unit comprises:
a discharging unit configured to discharge the second predetermined amount of charges from the first charge accumulating unit, and
a pulse signal generating unit which, as the predetermined processing, is configured to generate the pulse signal by using a voltage signal generated based on the second predetermined amount of charges discharged from the first charge accumulating unit by the discharging unit.

6. The neuron element according to claim 5,
wherein the discharging unit further comprises:
a second charge accumulating unit;
a determining unit configured to output a first selecting signal based on the condition when the charges accumulated in the first charge accumulating unit is determined to exceed the first predetermined amount of charges, and output a second selecting signal based on a condition when the charges accumulated in the first charge accumulating unit is determined to fall below the first predetermined amount of charges; and
a connection switching unit configured to connect the first charge accumulating unit and the second charge accumulating unit in parallel based on outputting of the first selecting signal from the determining unit, and connect a resistive load, which corresponds to the pulse signal generating unit, and the second charge accumulating unit in parallel based on outputting of the second selecting signal from the determining unit,
wherein the second charge accumulating unit, when connected in parallel with the first charge accumulating unit by the connection switching unit, is configured to accumulate the second predetermined amount of charges discharged from the first charge accumulating unit, and
wherein the resistive load, when connected in parallel with the second charge accumulating unit by the connection switching unit, is configured to generate a voltage signal corresponding to the pulse signal based on the second predetermined amount of charges accumulated in the second charge accumulating unit.

7. The neuron element according to claim 6,
wherein, when a maximum instantaneous input current of the input signal is Iₘₐₓ, a capacitance of the first charge accumulating unit is C_{A}, a threshold voltage for detecting the first predetermined amount of charges is Vₜₕ, a source voltage is V_{DD}, a capacitance of the second charge accumulating unit is C_{B}, a resistance value of the resistive load is R, and a delay period, from a time when a voltage generated at the first charge accumulating unit exceeds the threshold voltage Vₜₕ to a time of the connecting by the connection switching unit, is D_{cmp}, then D_{cmp} is less than (C_{A} · C_{B})/(C_{A} + C_{B})(V_{DD}/Iₘₐₓ - R).

8. A differential neuron element comprising:
a charge accumulating unit which accumulates charges by a first input signal and a second input signal, the second input signal obtained by inverting a polarity of the first input signal;
a signal processing unit which, based on a condition when the charges accumulated in the charge accumulating unit exceed a first predetermined amount of charges, is configured to:
discharge a second predetermined amount of charges from the charge accumulating unit; and
generate a first pulse signal and a second pulse signal, the second pulse signal obtained by inverting a polarity of the first pulse signal,
wherein the signal processing unit performs a predetermined processing in relation to the second predetermined amount of charges and the pulse signal.

9. An A/D converter comprising:
a charge accumulating unit which accumulates charges by an input signal;
a signal processing unit which, based on a condition when the charges accumulated in the charge accumulating unit exceed a first predetermined amount of charges, is configured to:
discharge a second predetermined amount of charges from the charge accumulating unit, and
generate a pulse signal; and
a digital filter configured to perform a predetermined digital processing on the pulse signal generated by the signal processing unit,
wherein the signal processing unit performs a predetermined processing in relation to the second predetermined amount of charges and the pulse signal.

10. A neural network comprising a plurality of neuron elements including the neuron element of claim 1,
wherein an input signal of any one of the neuron elements is obtained by a weighting addition processing of at least one of signals of at least one external input signal and an output signal of at least another one of the neuron elements,
wherein an output signal of the any one of the neuron element becomes at least one of signals of at least one external output signal and a weighted input signal of the at least another one of the neuron elements.
